(19) United States
(12) Patent Application Publication
(10) Pub. No.: US 2020/0311176 A1
(43) Pub. Date: Oct. 1, 2020

(54) Web Page Duplication

(71) Applicant: Citrix Systems, Inc., Fort Lauderdale, FL (US)

(72) Inventors: Yuran Ou, Nanjing City (CN); Peng Yao, Nanjing City (CN)

(21) Appl. No.: 16/436,090

(22) Filed: Jun. 10, 2019

Related U.S. Application Data
(63) Continuation of application No. PCT/CN19/80852, filed on Apr. 1, 2019.

(51) Int. Cl. G06F 16/958; G06F 16/957; H04L 29/08; G06F 3/14

(52) U.S. Cl. CPC G06F 16/986; G06F 3/1415; H04L 67/2823; G06F 16/9577

(57) ABSTRACT

When a user interacts with a web page application rendered and displayed by a browser on a device, changes to the web page associated with the user interaction might not be identically or otherwise appropriately rendered and displayed across browsers and/or devices that are different from the user's browser and device. Thus, it is important to ensure compatibility of web content across different browsers and/or devices during front end development and testing of a web page application. Systems and methods according to the present disclosure detect changes affecting a web page rendered by a browser on a device and synchronously or asynchronously duplicate the detected changes in the copies of the web page rendered and displayed by different browsers and/or devices.

### CROSS REFERENCE TO RELATED CASE

This application claims priority to and is a continuation of PCT International Application No. PCT/CN2019/080852, filed Apr. 1, 2019, hereby incorporated by reference in its entirety.

### FIELD

Aspects described herein generally relate to web development. More specifically, aspects described herein provide systems and methods for web content compatibility across browsers and/or devices.

### BACKGROUND

A web browser is software that allows a user to find and view websites on the World Wide Web. The web browser may provide a User Interface (UI) for viewing and navigating the websites. Some examples of web browsers are Google Chrome, Internet Explorer, Safari, Microsoft Edge and Mozilla Firefox. A website may include one or more web pages. A web page (or webpage) is a document commonly written in HTML (Hypertext Markup Language). In addition to html, the web page may include references to resources, such as images, Cascading Style Sheets (CSS) and scripts, such as JavaScript. A website and its web pages may be hosted on a server, such as a web server. When a web page is accessed within a web browser, the html and/or resources of the web page are requested from the web server. Accessing a web page in a browser may include specifying a URL in the browser, clicking on a link or refreshing a displayed web page. The web server may respond to the request by providing the requested html and/or resources for the web page.

A browser engine (also referred to as a rendering engine or layout engine) is a component of a web browser that transforms the html document and other resources of a web page into a visual representation within the browser's User Interface (UI). When the browser receives a html document, the browser engine parses the html document and builds or constructs a DOM (Document Object Model) for the web page. The DOM is an object-oriented representation of the html document. The DOM acts as an interface to the html document. Programs and scripts, such as JavaScript, can dynamically access and update the content, structure and style of the web page document by interfacing with the DOM of the web page. The browser may also modify or update the DOM of the web page in response to browser events. The browser events may be associated with user actions, such as clicking on links, mouse and pointer movements, keyboard input or any other action in which the user interacts with the web page in the web browser.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

The disclosed subject matter relates to a computer-implemented method that includes receiving a web page requested by a first browser running on a first computing device. The method may include providing the received web page as a first web page to the first browser running on the first computing device. The first web page may be rendered and displayed by the first browser. The method may also include generating a second web page by duplicating the received web page. The method includes providing the second web page to a second browser running on a second computing device. The provided second web page may be rendered and displayed by the second browser. The method further includes monitoring the first web page rendered and displayed by the first browser for at least one change affecting the first web page. The method also includes based on detecting the at least one change affecting the first web page rendered and displayed by the first browser, duplicating in the second web page rendered and displayed by the second browser, the detected at least one change affecting the first web page.

The disclosed subject matter also relates to a system includes one or more processors, and a memory storing computer-readable instructions. The computer-readable instructions, when executed by the one or more processors, may configure the one or more processors to receive a web page requested by a first browser running on a first computing device. The computer-readable instructions, when executed by the one or more processors, may configure the one or more processors to provide the received web page as a first web page to the first browser running on the first computing device. The first web page may be rendered and displayed by the first browser. The instructions may further configure the one or more processors to generate a second web page by duplicating the received web page. The instructions may configure the one or more processors to provide the second web page to a second browser running on a second computing device. The provided second web page may be rendered and displayed by the second browser. The instructions may configure the one or more processors to monitor the first web page rendered and displayed by the first browser for at least one change affecting the first web page. The instructions may also configure the one or more processors to, based on detecting the at least one change affecting the first web page rendered and displayed by the first browser, duplicate in the second web page rendered and displayed by the second browser, the detected at least one change affecting the first web page.

The disclosed subject matter also relates to a machine readable medium including instructions stored therein, which when executed by a machine, cause the machine to perform operations including receiving a web page requested by a first browser running on a first computing device. The operations may include providing the received web page as a first web page to the first browser running on the first computing device. The first web page may be rendered and displayed by the first browser. The operations may also include generating a second web page by duplicating the received web page. The operations include providing the second web page to a second browser running on a second computing device. The provided second web page may be rendered and displayed by the second browser. The operations further include monitoring the first web page rendered and displayed by the first browser for at least one change affecting the first web page. The operations also include based on detecting the at least one change affecting the first web page rendered and displayed by the first browser, duplicating in the second web page rendered and displayed by the second browser, the detected at least one change affecting the first web page.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 illustrates an example environment for web page development in accordance with one or more illustrative aspects described herein.

FIG. 5 illustrates an example process for web page development performed by the example embodiment of FIG. 4.

FIG. 6 illustrates an example process for web page duplication performed by the example embodiment of FIG. 4.

FIG. 7 illustrates another illustrative environment for web page development in accordance with one or more illustrative aspects described herein.

FIG. 8 illustrates another illustrative environment for web page development in accordance with one or more illustrative aspects described herein.

FIG. 9 illustrates another illustrative environment in which a web page development service is provided in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

The same web page content may not be rendered and displayed identically or closely across different browsers and/or devices. This may be due to differences in viewports, CPUs, and other factors across different devices or due to varying rendering engines and rendering capabilities across different browsers. For example, differences between rendering engines and rules may cause some fonts in a web page to be displayed differently or inconsistently between different browsers. Inconsistencies in the rendering and displaying of a web page or website across different user environments may negatively impact the overall user experience. Additionally, web developers are encouraged to create an engaging user experience by providing interactive features in web pages and websites, such as live chat, pop-up and help screens. However, differences in rendering engines and/or device hardware may cause a website to not work as intended on some browsers and/or devices. Identifying cross-browser and cross-device compatibility issues during web development enables a web developer to better determine which interactive features to include in a website.

As discussed above, identifying inconsistencies in the rendering of a website across browsers and/or devices is an important aspect of web development. Systems, methods and devices described herein duplicate user interaction with a web page across different browsers and/or devices. According to example systems and methods, a master web page may be rendered and displayed by a master browser executing on a master device. The web page may also be rendered and displayed as a second web page (referred to as a replica web page) across one or more browsers (referred to as replica browsers) executing respectively on one or more client devices (referred to as replica devices) that may be different from each other. The one or more replica browsers may be different from each other. The master browser may monitor the master web page for changes to the master web page. The changes may be associated with user interaction with the master web page in the master browser. User interaction may include any user actions related to the web page rendered and displayed in the master browser, such as clicking on links, mouse and pointer movements, keyboard input or any other action in which the user interacts with the web page in the web browser. In some embodiments, detecting changes associated with user interaction with the master web page rendered and displayed in the master browser may include detecting one or more changes to the DOM of the master web page. Based on detecting user interaction with the master web page rendered and displayed in the master browser, example systems and methods duplicate or replicate the detected user interaction in the replica web page that is rendered and displayed in each of the replica browsers. In some embodiments, the detected user interaction is duplicated or replicated simultaneously across the replica browsers in real-time. The user interaction associated with the master web page may be duplicated or replicated in the replica web pages by modifying or updating the DOM representations of the replica web pages according to the detected changes to the DOM of the master web page. In this manner, the user interaction with the master web page in the master browser is duplicated or replicated across multiple browsers and/or devices and any inconsistencies in the rendering of the user interaction in the replica web pages across the multiple browsers and/or devices may be efficiently detected and identified during web development. Identifying inconsistent rendering of interactive website and web applications during web development enables a web developer to improve the user experience of the website or web application.

In some embodiments, the detected changes to the master web page associated with user interaction may be stored in a database. The replica devices may be connected to the database. The stored user interaction may be propagated across the replica browsers. The replica browsers may duplicate or replicate the changes associated with the stored user interaction in the respective web pages rendered and displayed by the replica browsers.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect connecting and coupling.

Computing Architecture

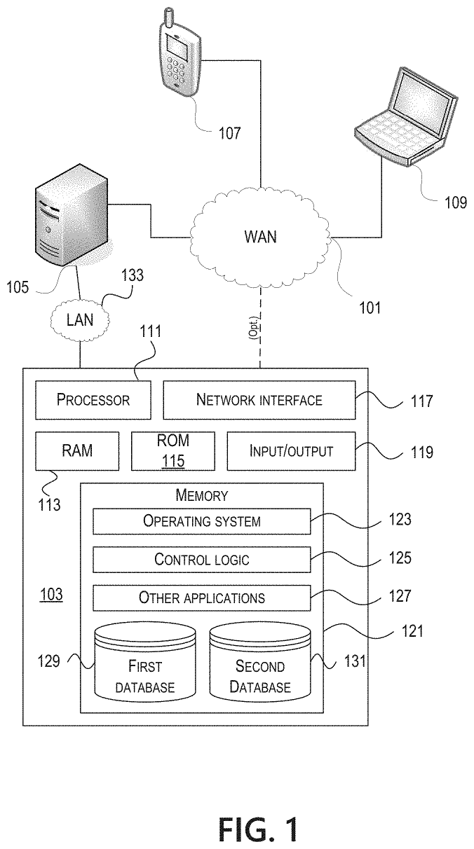

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communications paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

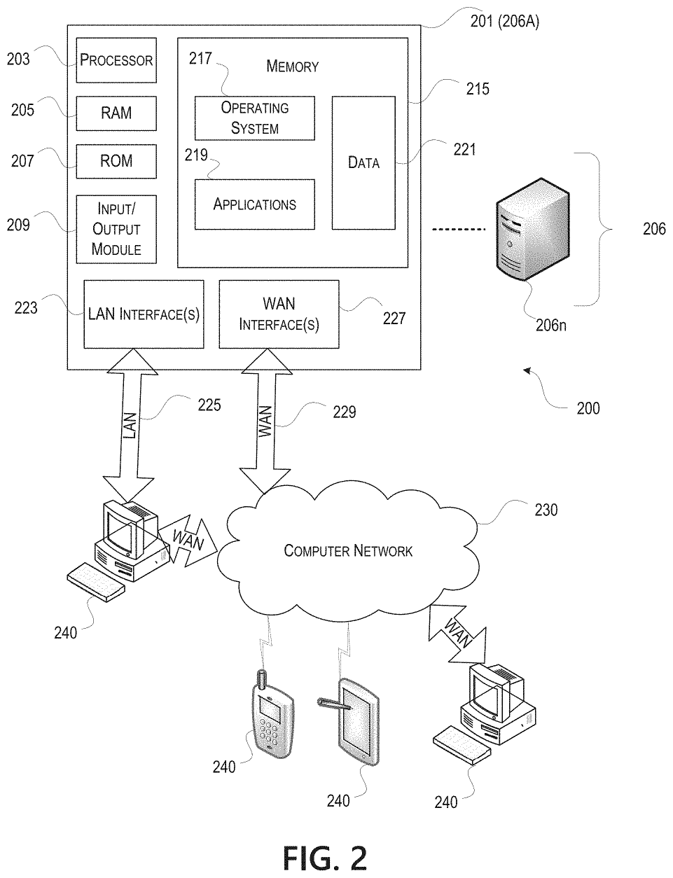

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, SYMBIAN, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

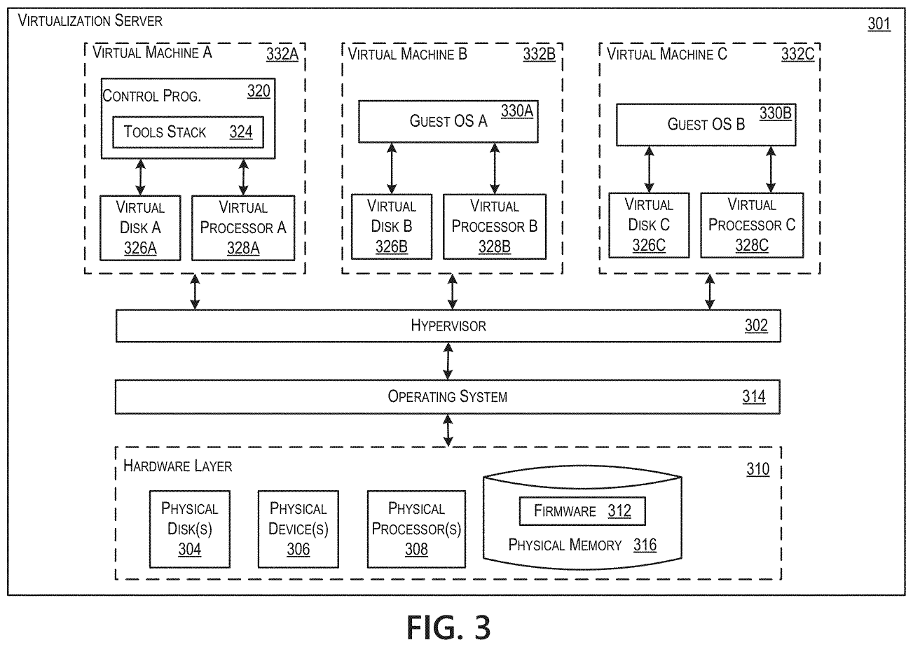

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, Calif.; the XENPROJECT hypervisor, an open source product whose development is overseen by the open source XenProject.org community; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

Web Page Duplication

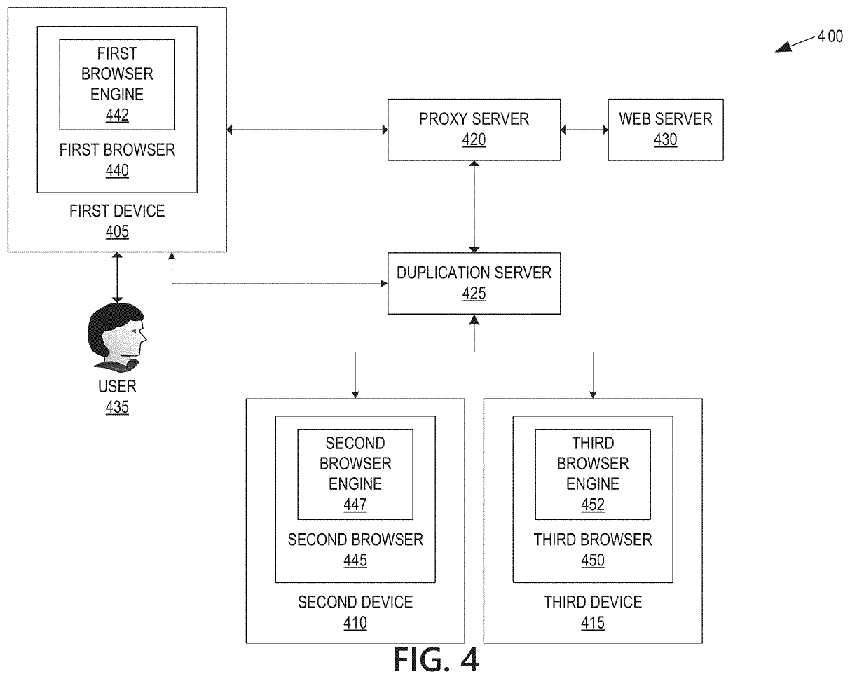

FIG. 4 illustrates an example environment for web page development in accordance with one or more illustrative aspects described herein. The environment 400 includes a first device 405, a second device 410 and a third device 415. In some embodiments, the first, second and third devices 405, 410, and 415 may each be a computing device 210 shown in FIG. 2. The environment 400 also includes first server, such as a proxy server 420, a second server, such as a duplication server 425, and a third server, such as a web server 430. In some embodiments, the proxy server 420, the duplication server 425 and the web server 430 may each be a server 206 shown in FIG. 2. In some embodiments, the

A first browser 440 executes on the first device 405. The first browser 440 includes a first browser engine 442. A user 435 of the first browser 440 may access a web page from the first browser 440. Based on the user 435 accessing the web page, the first browser 440 may request the accessed web page from the web server 430 via the proxy server 420. The web server 430 may respond to the request for the web page by providing the requested web page to the proxy server 420. The proxy server 420 may receive the web page provided by the web server 430. The web page may be any type of web page including a static web page or a web application.

The proxy server 420 may provide the received web page as a first web page to the first browser 440. After the first browser 440 receives the first web page from the proxy server 420, the first browser 440 may render and display the first web page for the user 435 of the first device 405. A web page, such as the web page accessed by the user 435 of the first browser 440, may be rendered and displayed differently across different browsers and devices. Therefore, in addition to providing the web page received from the web server 430 as a first web page to the first browser 440, the web page may also be provided as a second web page to the second and third browsers 445 and 450. In some embodiments, the proxy server 420 may receive the web page from the web server 430 and provide the web page to the duplication server 425. In some embodiments, the proxy server 420 may provide the duplication server 425 with a copy of the html and/or resources of the web page received from the web server 430. After the duplication server 425 receives the web page from the proxy server 420, the duplication server 425 may provide the received web page as a duplicated web page to the second browser 445 executing on the second device 410 and a third browser 450 executing on the third device 415. The second and third browsers 445 and 450 may each render and display the duplicated web page.

After the web page accessed by the user 435 of the first browser 440 is rendered and displayed by each of the first, second and third browsers 440, 445 and 450, changes to the first web page rendered and displayed by the first browser 440 may be duplicated or replicated in the web pages rendered by the second and third browsers 445 and 450. In some embodiments, the changes to the first web page may be associated with the user 435 interacting with the first web page in the first browser 440. By duplicating or replicating the user interaction with the first web page in the web pages rendered and displayed by the second and third browsers 445 and 450, instances of inconsistent rendering of the web page content across the browsers and/or devices may be identified during web development. While FIG. 4 shows a second and third browser 445 and 450, web page duplication may occur across any number of browsers and/or devices.

In some embodiments, after the proxy server 420 receives the web page from the web server 430, the proxy server 420 may inject or provide a script in the web page and provide the web page with the injected script as a first web page to the first browser 440. In some embodiments, the injected script may be JavaScript. When the first browser engine of the first browser 440 renders the first web page, the injected script executes and may configure the first browser 440 to monitor the first web page for changes affecting the rendered and displayed first web page. In some embodiments, the changes affecting the first web page may be associated with the user 435 interacting with the first web page in the first browser 440. In some embodiments, the injected script may configure the first browser 440 to monitor for and detect changes to the DOM of the first web page rendered and displayed by the first browser 440. The script may also configure the first browser 440 to provide the detected changes to the duplication server 425. In some embodiments, the first browser 440 may provide the changes to the DOM of the first web page to the duplication server 425. In some embodiments, the first browser 440 provides the new or changed DOM of the first web page to the duplication server 425. After receiving the changes to the first web page, the duplication server 425 may provide the changes to the second and third browsers 445 and 450.

In some embodiments, the second and third browsers 445 and 450 may be configured to receive the changes to the first web page from the duplication server 425. As discussed above, after the duplication server 425 receives the web page from the proxy server 420, the duplication server 425 may provide the received web page as a duplicated web page to the second and third browsers 445 and 450. In some embodiments, the duplication server 425 may include, inject or provide a script in the duplicated web page to the second and third browsers 445 and 450. In some embodiments, the injected script may be JavaScript. The injected script may configure the second and third browsers 445 and 450 to receive the changes to the first web page from the duplication server 425.

The injected script may also configure the second and third browsers 445 and 450 to duplicate or replicate the changes in the web pages rendered and displayed by the second and third browsers 445 and 450. In some embodiments, after receiving the changes to the first web page from the duplication server 425, the second and third browsers 445 and 450 may update and modify the respective DOM of the web pages rendered and displayed by the second and third browsers 445 and 450 based on the changes to the DOM of the first web page. After the changes to the first web page are duplicated or replicated in the second and third browsers 445 and 450, instances of inconsistent rendering of the web page content across the second and third browsers 445 and 450 and/or devices 410 and 415 may be identified during web development.

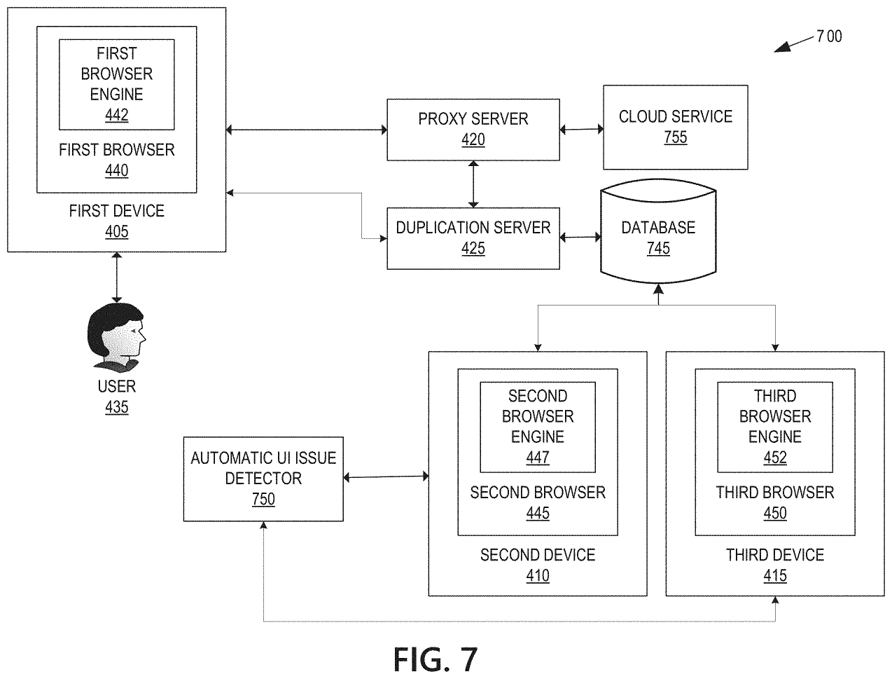

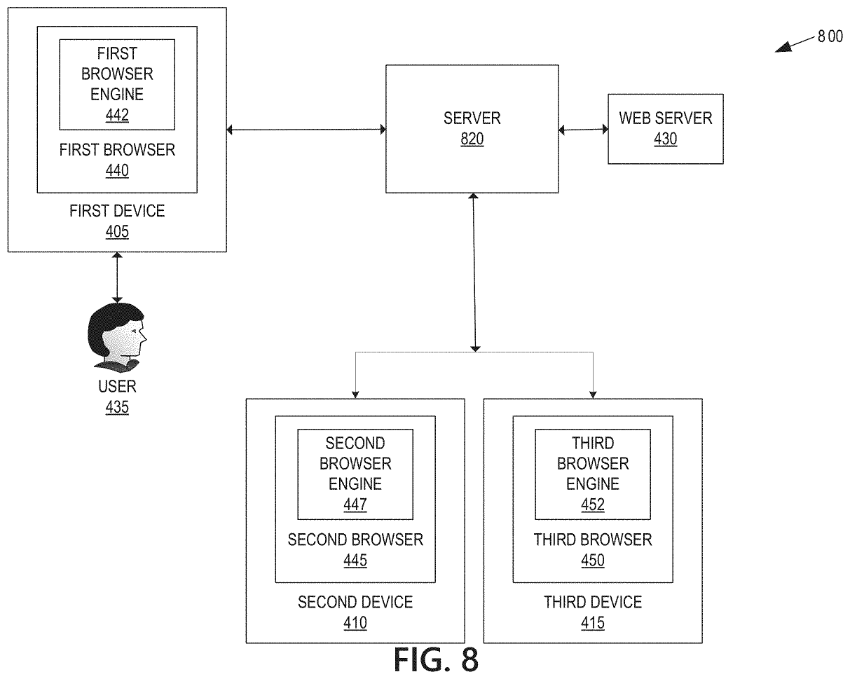

In some embodiments, the functionality of the duplication server 425 and the proxy server 425 may be provided by a single server. FIG. 8 shows an example embodiment in which the functionality provided by the proxy server 425 and the duplication server 425 is provided by a single server 820. In some embodiments, the web development functionality described with reference to FIG. 4 may be provided as a cloud service, such as the cloud service 755 shown in FIG. 7. In FIG. 7, the cloud service 755 interfaces with the proxy server 420. The duplication server 425 may be connected to the second and third browsers 445 and 450 via a database 745. The user interaction described with reference to FIG. 4 may be recorded or stored in the database 745. The second and third browsers 445 and 450 may interface with an automatic UI issue detector 750. The user interaction may be duplicated or replicated by the second and third browsers 445 and 450. Additionally, instances of inconsistent rendering of the web page content across the second and third browsers 445 and 450 and/or devices 410 and 415 may be identified by the automatic UI issue detector 750 that is connected to the second and third browsers 445 and 450.

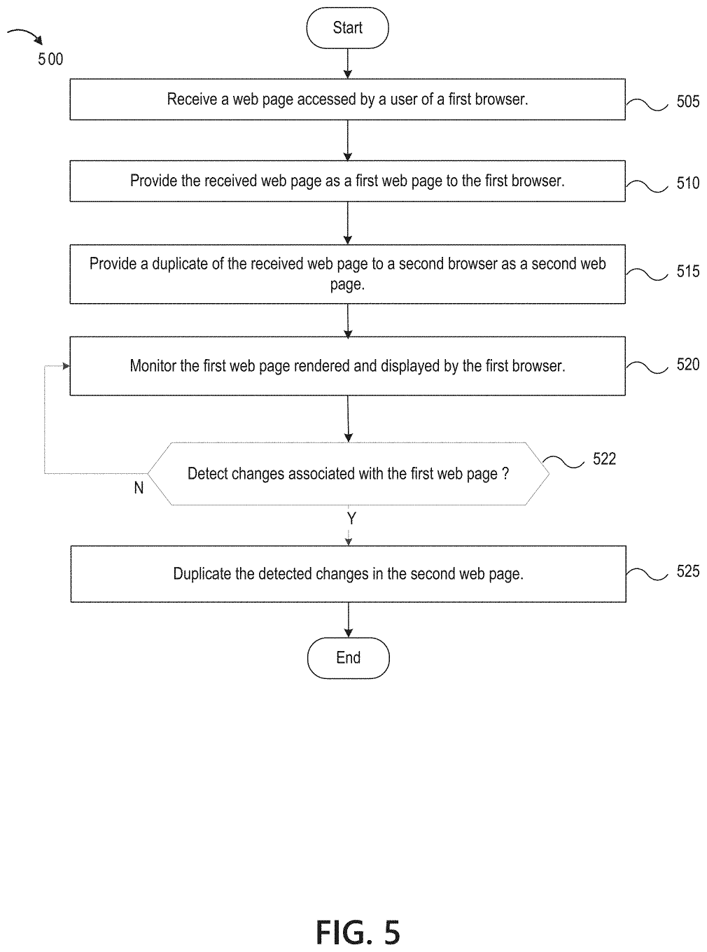

FIG. 5 illustrates an example process 500 for web page development by the example embodiment of FIG. 4. The process 500 may include web page duplication. While FIG. 5 is described with reference to FIG. 4, it should be noted that the method steps of FIG. 5 may be performed by other systems.

When a user 435 of a first browser 440 running on the first device 405 accesses a web page from the first browser 440, the first browser engine 442 of the first browser 440, sends a request (e.g., http/https request) for the web page accessed by the user 435 of the first browser 440 to the proxy server 420. The proxy server 420 forwards the request for the accessed web page to the web server 430. The web server 430 receives the request from the proxy server 420. The web server 430 responds to the request received from the proxy server 420 by providing the html of the web page to the proxy server 420. The proxy server 420 receives the html of the web page from the web server 430.

The process 500 begins at stage 505 when the proxy server 420 receives the html of the web page accessed by the user 435 of the first browser 440. The web page may be any type of web page including a static web page or a web application. At stage 510, the process 500 includes providing the received web page as a first web page to the first browser 440. The proxy server 420 may provide the received web page as a first web page to the first browser 440. After the first browser 440 receives the first web page from the proxy server 420, the first browser 440 may render and display the first web page for the user 435 of the first device 405.

In stage 515, the process 500 includes providing a duplicate of the received web page to a second browser as a second web page. A web page, such as the web page accessed by the user 435 of the first browser 440, may be rendered and displayed differently across different browsers and devices. Therefore, in addition to providing the web page received from the web server 430 as a first web page to the first browser 440, the web page may also be provided as a second web page to the second and third browsers 445 and 450. In some embodiments, the proxy server 420 may receive the web page from the web server 430 and provide the web page to the duplication server 425. In some embodiments, the proxy server 420 may provide the duplication server 425 with a copy of the html and/or resources of the web page received from the web server 430. After the duplication server 425 receives the web page from the proxy server 420, the duplication server 425 may provide the received web page as a second web page to the second browser 445 executing on the second device 410 and a third browser 450 executing on the third device 415. The second and third browsers 445 and 450 may each render and display the second web page.

After the web page accessed by the user 435 of the first browser 440 is rendered and displayed by each of the first, second and third browsers 440, 445 and 450, changes to the first web page rendered and displayed by the first browser 440 may be duplicated or replicated in the web pages rendered by the second and third browsers 445 and 450. In some embodiments, the changes to the first web page may be associated with the user 435 interacting with the first web page in the first browser 440. By duplicating or replicating the user interaction with the first web page in the web pages rendered and displayed by the second and third browsers 445 and 450, instances of inconsistent rendering of the web page content across the browsers and/or devices may be identified during web development. While FIG. 4 shows a second and third browser 445 and 450, web page duplication may occur across any number of browsers and/or devices.

In stage 520, the process 500 includes monitoring the first web page rendered and displayed by the first browser 440. After the proxy server 420 receives the web page from the web server 430, the proxy server 420 may inject or provide a script in the web page and provide the web page with the injected script as a first web page to the first browser 440. In some embodiments, the injected script may be JavaScript. When the first browser engine of the first browser 440 renders the first web page, the injected script executes and may configure the first browser 440 to monitor the first web page for changes affecting the rendered and displayed first web page. In some embodiments, the changes affecting the first web page may be associated with the user 435 interacting with the first web page in the first browser 440. In some embodiments, the injected script may configure the first browser 440 to monitor for and detect changes to the DOM of the first web page rendered and displayed by the first browser 440. The script may also configure the first browser 440 to provide the detected changes to the duplication server 425.

In stage 522, the process 500 includes determining whether a change affecting the first web page has been detected. If the first browser 440 has not detected a change to the DOM of the first web page, the process 500 returns to stage 520 and the first browser 440 continues to monitor the first web page. If the first browser 440 detects a change to the DOM of the first web page, the process 500 proceeds to stage 525. The first browser 440 may provide the changes to the DOM of the first web page to the duplication server 425. In some embodiments, the first browser 440 provides the new or changed DOM of the first web page to the duplication server 425. After receiving the changes to the first web page, the duplication server 425 may provide the changes to the second and third browsers 445 and 450.

In stage 525, the process 500 includes duplicating or replicating the changes to the first web page in the web pages rendered and displayed by the second and third browsers 445 and 450 and the process ends. In some embodiments, the second and third browsers 445 and 450 may be configured to receive the changes to the first web page from the duplication server 425. As discussed above, after the duplication server 425 receives the web page from the proxy server 420, the duplication server 425 may provide the received web page as a duplicated web page to the second and third browsers 445 and 450. In some embodiments, the duplication server 425 may include, inject or provide a script in the duplicated web page to the second and third browsers 445 and 450. In some embodiments, the injected script may be JavaScript. The injected script may configure the second and third browsers 445 and 450 to receive the changes to the first web page from the duplication server 425.

The injected script may also configure the second and third browsers 445 and 450 to duplicate or replicate the changes in the web pages rendered and displayed by the second and third browsers 445 and 450. In some embodiments, after receiving the changes to the first web page from the duplication server 425, the second and third browsers 445 and 450 may update and modify the respective DOM of the web pages rendered and displayed by the second and third browsers 445 and 450 based on the changes to the DOM of the first web page. After the changes to the first web page are duplicated or replicated in the second and third browsers 445 and 450, instances of inconsistent rendering of the web page content across the second and third browsers 445 and 450 and/or devices 410 and 415 may be identified during web development.

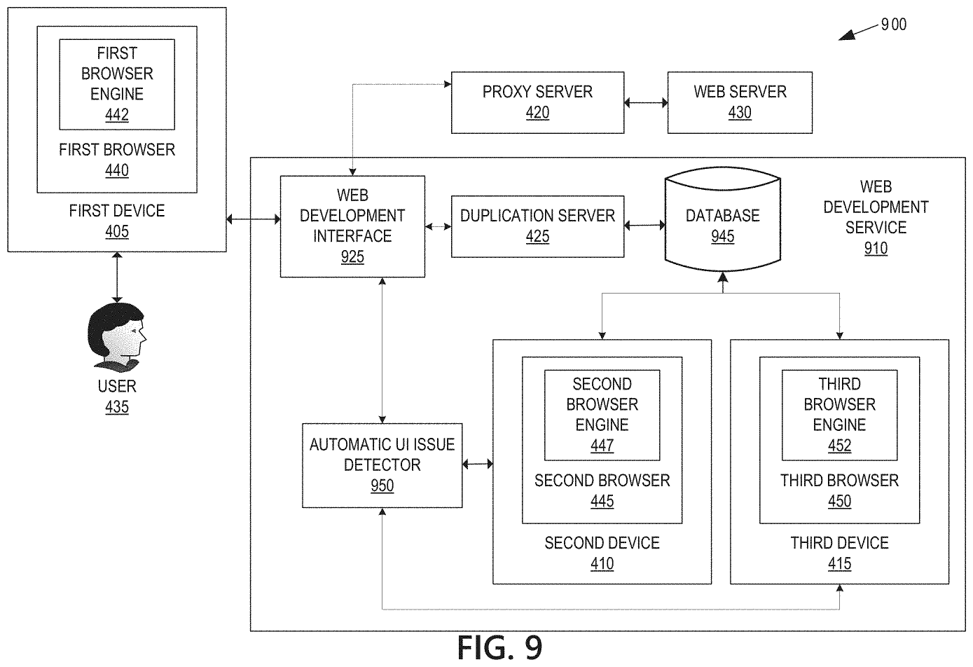

The process 500 may be performed by other systems, such as the system 900 shown in FIG. 9. In some embodiments, as shown in FIG. 9, the process 500 in FIG. 5 may be implemented by a web development service 910. When a user 435 of a first browser 440 running on the first device 405 accesses a web page from the first browser 440, the first browser engine 442 of the first browser 440, sends a request (e.g., http/https request) for the web page accessed by the user 435 of the first browser 440 to the proxy server 420 via the web development interface 925. In some embodiments, the user 435 may be a web developer and the web development service 910 may be provided as a cloud service. The web development service may include a web development interface 925. The proxy server 420 forwards the request for the accessed web page to the web server 430. The web server 430 receives the request from the proxy server 420. The web server 430 responds to the request received from the proxy server 420 by providing the html of the web page to the proxy server 420.

The proxy server 420 may provide the received web page as a first web page to the first browser 440 via the web development interface 925. After the first browser 440 receives the first web page from the web development service 925, the first browser 440 may render and display the first web page for the user 435 of the first device 405. A web page, such as the web page accessed by the user 435 of the first browser 440, may be rendered and displayed differently across different browsers and devices. Therefore, in addition to providing the web page received from the web server 430 as a first web page to the first browser 440, the web page may also be provided as a second web page to the second and third browsers 445 and 450. In some embodiments, the web development interface 925 may receive the web page from the proxy server 420 and provide the web page to the duplication server 425. In some embodiments, the web development interface 925 may provide the duplication server 425 with a copy of the html and/or resources of the web page received from the web server 430. After the duplication server 425 receives the web page from the web development interface 925, the duplication server 425 may store or record the received web page as a duplicated web page in a database 745.

After the web page accessed by the user 435 of the first browser 440 is rendered and displayed by the first browser 440, changes to the first web page rendered and displayed by the first browser 440 may be stored and recorded in the database 745. In some embodiments, the changes to the first web page may be associated with the user 435 interacting with the first web page in the first browser 440. The user interaction may be recorded or stored in the database 745 and duplicated or replicated in the second and third browsers 445 and 450 at a later time. By duplicating or replicating the user interaction with the first web page in the web pages rendered and displayed by the second and third browsers 445 and 450, instances of inconsistent rendering of the web page content across the browsers and/or devices may be identified during web development. While FIG. 9 shows a second and third browser 445 and 450, web page duplication may occur across any number of browsers and/or devices.

In some embodiments, after the web development interface 925 receives the web page from the web server 430 via the proxy server 420, the web development interface 925 may inject or provide a script in the web page and provide the web page with the injected script as a first web page to the first browser 440. In some embodiments, the injected script may be JavaScript. When the first browser engine of the first browser 440 renders the first web page, the injected script executes and may configure the first browser 440 to monitor the first web page for changes affecting the rendered and displayed first web page. In some embodiments, the changes affecting the first web page may be associated with the user 435 interacting with the first web page in the first browser 440. In some embodiments, the injected script may configure the first browser 440 to monitor for and detect changes to the DOM of the first web page rendered and displayed by the first browser 440. The script may also configure the first browser 440 to provide the detected changes to the duplication server 425 via the web development interface 925. In some embodiments, the first browser 440 may provide the changes to the DOM of the first web page to the duplication server 425 via the web development interface 925. In some embodiments, the first browser 440 provides the new or changed DOM of the first web page to the duplication server 425 via the web development interface 925. After receiving the changes to the first web page, the duplication server 425 may store and record the changes in the database 945.

In some embodiments, the second and third browsers 445 and 450 may be configured to receive the changes to the first web page from the database 945. As discussed above, after the duplication server 425 receives the web page from proxy server 420 via the web development interface 925, the duplication server 425 may store or record the received web page as a duplicated web page in the database 945. In some embodiments, the duplication server 425 may include, inject or provide a script in the duplicated web page. In some embodiments, the injected script may be JavaScript. The injected script may configure the second and third browsers 445 and 450 to receive the changes to the first web page from the database 745.

The injected script may also configure the second and third browsers 445 and 450 to receive the changes stored in the database 945 and duplicate or replicate the changes in the web pages rendered and displayed by the second and third browsers 445 and 450. In some embodiments, after receiving the changes to the first web page from the database 745, the second and third browsers 445 and 450 may update and modify the respective DOM of the web pages rendered and displayed by the second and third browsers 445 and 450 based on the changes to the DOM of the first web page. After the changes to the first web page are duplicated or replicated in the second and third browsers 445 and 450, instances of inconsistent rendering of the web page content across the second and third browsers 445 and 450 and/or devices 410 and 415 may be identified during web development. The second and third browsers 445 and 450 may interface with an automatic UI issue detector 950. Instances of inconsistent rendering of web page content across the second and third browsers 445 and 450 and/or devices 410 and 415 may be identified by the automatic UI issue detector 950. The automatic UI issue detector 950 may provide information about inconsistent rendering of web page content across the second and third browsers 445 and 450 and/or devices 410 and 415 to the web development interface 925 which in turn may provide the information to the user 435.

In this manner, a web developer may use the web development service 910 to efficiently build and improve web applications or web pages. During web development, the web developer may access and interact with a web page in the first browser 440. Using the web development service 910, the accessed web page is stored in the database 945 as a duplicated web page. The user interaction with the web page is also stored or recorded in the database 945. The web developer may, at a later time, user the web development service 910 to sync the stored duplicated web page across multiple browsers and/or devices. The user interaction stored in the database 945 is duplicated or replicated across the browsers and/or devices. Inconsistent rendering of web content across the browsers and/or devices may be detected by the automatic UI issue detector 950 and reported to the web developer.

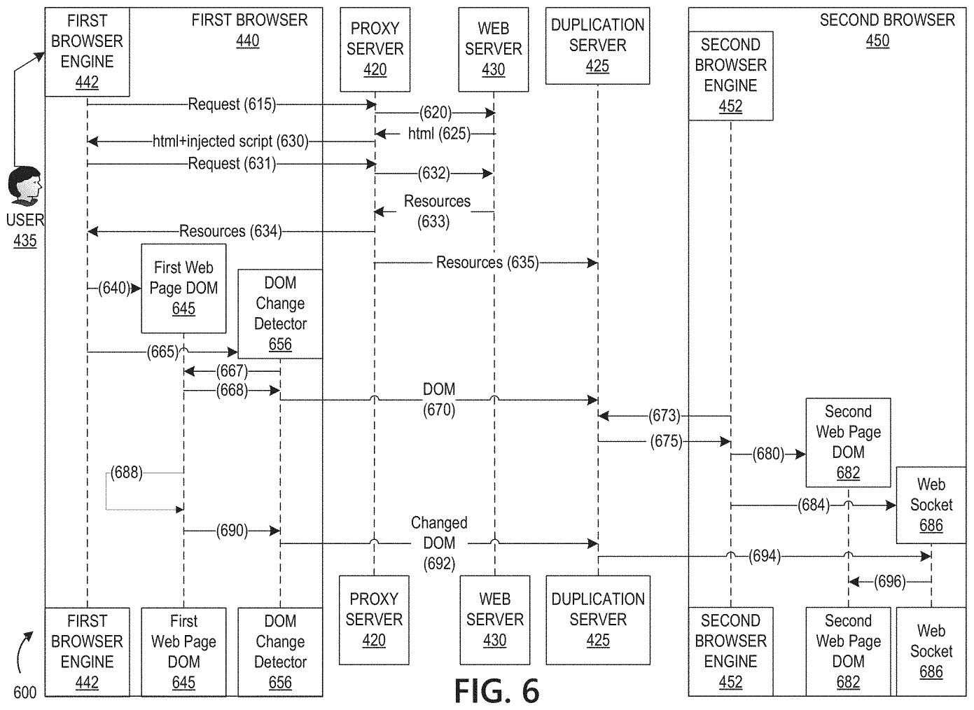

FIG. 6 illustrates an example process 600 for web page duplication performed by the example embodiment of FIG. 4. While FIG. 6 is described with reference to FIG. 4, it should be noted that the steps of FIG. 6 may be performed by other systems.

As shown in stage 615, when a user 435 of a first browser 440 running on the first device 405 accesses a web page from the first browser 440, the first browser engine 442 of the first browser 440, sends a request (e.g., http/https request) for the web page accessed by the user 435 of the first browser 440 to the proxy server 420. As shown in stage 620, the proxy server 420 forwards the request for the accessed web page to the web server 430. In stage 625, after the web server 430 receives the request from the proxy server 420, the web server 430 responds by providing the html of the web page to the proxy server 420.

In stage 630, after the proxy server 420 receives the html of the web page from the web server 430, the proxy server 420 injects a script, such as a DOM change detector 656, in the web page received from the web server 430 and provides the web page with the DOM change detector 656 as a first web page to the first browser 440. In some embodiments, the injected script may be JavaScript. After the first browser 440 receives the html of the first web page from the proxy server 420, the first browser engine 442 of the first browser 440 may render the first web page. If the html of the first web page references resources, such as CSS, images and fonts, the first browser 440 may request the resources from the web server 430. In stage 631, the first browser 440 sends a request for the resources referenced in the web page to the proxy server 420. In stage 632, after the proxy server 420 receives the request for the resources referenced in the first web page, the proxy server 420 forwards the request to the web server 430. In stage 633, the web server 430 responds to the request by providing the resources to the proxy server 420. In stage 634, after the proxy server 420 receives the resources referenced by the first web page from the web server 430, the proxy server 420 provides the resources to the first browser engine 442 of the first browser 440. In stage 635, after the proxy server 420 receives the resource referenced by the first web page from the web server 430, the proxy server 420 also provides the resources to the duplication server 425. Based on the html and resources of the first web page, the first browser engine 442 of the first browser 440 renders the first web page. In stage 640, the first browser engine 442 builds a DOM of the first web page (referred to as first web page DOM 645). Referring back to stage 630, the proxy server 420 injects a DOM change detector 656 into the html of the web page and provides the web page with the injected script as the first web page to the first browser 440. In stage 665, the DOM change detector 656 executes and as shown in the stages 665 and 666, the DOM change detector 656 gets the first web page DOM 645. In stage 670, the DOM change detector 656 provides the first web page DOM 645 to the duplication server 425.

In stage 673, the second browser 445 requests the duplication server 425 for a duplicated page. In stage 675, based on the request for a duplicated page, the duplication server 425 provides the resources referenced by the first web page and the first web page DOM 645 to the second browser 445. The duplication server 425 also provides a script with the first web page resources and the first web page DOM 645. In some embodiments, the script may be JavaScript. In stage 680, after the second browser 445 receives the first web page resources, first web page DOM 645 and the injected script from the duplication server 425, the second browser engine 452 of the second browser 445 renders a second web page and builds a DOM of the second web page (referred to as second web page DOM 682). The script provided by the duplication server 425 executes and in stage 684, establishes a web socket 686 between the duplication server 425 and the second browser 445.

In stage 688, the DOM change detector 656 may monitor the first web page DOM 645. As shown in stages 690 and 692, upon detecting a change to the first web page DOM 645, the DOM change detector 656 provides the detected change to the duplication server 425. In stage 694 the duplication server 425 provides the detected change to the second browser 450 via the web socket 686. In stage 694, after the duplication server 425 receives the detected change to the first web page DOM 645, the duplication server 425 provides the detected change to the second browser 445 via the web socket 686. In stage 696, after the change to the first web page DOM 645 is received via the web socket 686, the change to the first web page DOM 645 is duplicated or replicated in the second web page DOM 682.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
receiving a web page requested by a first browser running on a first computing device;
providing the received web page as a first web page to the first browser running on the first computing device, wherein the first web page is rendered and displayed by the first browser;
generating a second web page by duplicating the received web page;
providing the second web page to a second browser running on a second computing device, wherein the provided second web page is rendered and displayed by the second browser;
monitoring the first web page rendered and displayed by the first browser for at least one change affecting the first web page; and
based on detecting the at least one change affecting the first web page rendered and displayed by the first browser, duplicating in the second web page rendered and displayed by the second browser, the detected at least one change affecting the first web page.

2. The method of claim 1, further comprising:
configuring the first browser to:
monitor the first web page rendered and displayed by the first browser for at least one change affecting the first web page; and
based on detecting the at least one change affecting the first web page rendered and displayed by the first browser, provide the detected at least one change to the second browser.

3. The method of claim 2, further comprising:
configuring the second browser to:
receive the detected at least one change affecting the first web page from the first browser; and
based on receiving the detected at least one change affecting the first web page, duplicate in the second web page rendered and displayed by the second browser, the detected at least one change affecting the first web page.

4. The method of claim 1, wherein the at least one change affecting the first web page is associated with a user of the browser interacting with the first web page rendered and displayed by the first browser.

5. The method of claim 1, wherein the web page requested by the first browser running on a first computing device is a web page application.

6. The method of claim 1, wherein the at least one change affecting the first web page rendered and displayed by the first browser comprises at least one change to a Document Object Model (DOM) representation of the first web page.

7. The method of claim 6, wherein duplicating in the second web page rendered and displayed by the second browser, the detected at least one change affecting the first web page further comprises:
duplicating the at least one change to the DOM representation of the first web page in a DOM representation of the second web page.

8. The method of claim 1, wherein a first user interface of the first browser running on the first computing device is different from a second user interface of the second browser running on the second computing device.

9. The method of claim 1, wherein the first browser running on the first computing device is different from the second browser running on the second computing device.

10. A system comprising:
a memory; and
a processor coupled to the memory and configured to:
receive a web page requested by a first browser running on a first computing device;
provide the received web page as a first web page to the first browser running on the first computing device, wherein the first web page is rendered and displayed by the first browser;
generate a second web page by duplicating the received web page;
provide the second web page to a second browser running on a second computing device, wherein the provided second web page is rendered and displayed by the second browser;
monitor the first web page rendered and displayed by the first browser for at least one change affecting the first web page; and
based on detecting the at least one change affecting the first web page rendered and displayed by the first browser, duplicate in the second web page rendered and displayed by the second browser, the detected at least one change affecting the first web page.

11. The system of claim 10, wherein the processor is further configured to:
configure the first browser to:
monitor the first web page rendered and displayed by the first browser for at least one change affecting the first web page; and
based on detecting the at least one change affecting the first web page rendered and displayed by the first browser, provide the detected at least one change to the second browser.

12. The system of claim 10, wherein the processor is further configured to:
configure the second browser to:
receive the detected at least one change affecting the first web page from the first browser; and
based on receiving the detected at least one change affecting the first web page, synchronously duplicate in the second web page rendered and displayed by the second browser, the detected at least one change affecting the first web page.

13. The system of claim 10, wherein the at least one change affecting the first web page is associated with a user of the browser interacting with the first web page rendered and displayed by the first browser.

14. The system of claim 10, wherein the web page requested by the first browser running on a first computing device is a web page application.

15. The system of claim 10, wherein the at least one change affecting the first web page rendered and displayed by the first browser comprises at least one change to a Document Object Model (DOM) representation of the first web page.

16. The system of claim 15, wherein duplicating in the second web page rendered and displayed by the second browser, the detected at least one change affecting the first web page further comprises:
duplicating the at least one change to the DOM representation of the first web page in a DOM representation of the second web page.

17. The system of claim 10, wherein a first user interface of the first browser running on the first computing device is different from a second user interface of the second browser running on the second computing device.

18. The system of claim 10, wherein the first browser running on the first computing device is different from the second browser running on the second computing device.

19. A non-transitory machine readable storage medium comprising machine-readable instructions for causing a processor to execute a method comprising:
receiving a web page requested by a first browser running on a first computing device;
providing the received web page as a first web page to the first browser running on the first computing device, wherein the first web page is rendered and displayed by the first browser;
generating a second web page by duplicating the received web page;
providing the second web page to a second browser running on a second computing device, wherein the provided second web page is rendered and displayed by the second browser;
monitoring the first web page rendered and displayed by the first browser for at least one change affecting the first web page; and
based on detecting the at least one change affecting the first web page rendered and displayed by the first browser, duplicating in the second web page rendered and displayed by the second browser, the detected at least one change affecting the first web page.
